(19) United States
(12) Patent Application Publication
(10) Pub. No.: US 2011/0061767 A1
(43) Pub. Date: Mar. 17, 2011

(54) COMPONENT REMOVAL TOOL AND METHOD

(75) Inventors: John H. Vontell, Manchester, CT (US); Ronald W. Brush, Ringwood, NJ (US)

(73) Assignee: UNITED TECHNOLOGIES CORPORATION, Hartford, CT (US)

(21) Appl. No.: 12/559,120

(22) Filed: Sep. 14, 2009

(51) Int. Cl. B27L 7/00

(52) U.S. Cl. 144/195.7

(57) ABSTRACT

An apparatus includes a carriage, a first tooth, a second tooth, a feed block and a drive element. The first and second teeth are shaped for breaking bonds and attached to a first side of the carriage. The first and second teeth are spaced apart and generally parallel to each other. The drive element moves the carriage away from the feed block so that the first and second teeth break bonds when they encounter them. A method for removing a bonded component from a structure includes positioning a tool having first and second teeth between the component and the structure. The teeth are positioned between trailing edges of the component and the structure. The method includes driving the teeth from the trailing edges of the structure towards a leading edge of the structure to break bonds between the component and the structure so that the component can be removed.

### STATEMENT OF GOVERNMENT INTEREST

This invention was made, at least in part, with U.S. Government support under Contract No. N00019-02-C-3003, awarded by the United States Navy. The U.S. Government may have certain rights in this invention.

### BACKGROUND

Gas turbine engines are continually being enhanced to provide improved performance and durability and decreased size and weight for a given thrust rating while optimizing cost, producibility and repairability. Some gas turbine engines employ a fan inlet case that includes a ring strut ring. A ring strut ring generally includes an inner ring and an outer ring arranged concentrically. A number of struts connecting the inner and outer rings are spaced throughout the ring strut ring. The durability of the ring strut ring, and the struts in particular, may be enhanced by the use of fan inlet shroud fairings. Fan inlet shroud fairings are components with a U-shaped bend that surround the struts and help to provide additional physical protection and increase aerodynamics. Fan inlet shroud fairings may also incorporate electronic components such as ice protection heating elements and sensors. Typically, the fan inlet shroud fairings are bonded to the struts of the ring strut ring. It is necessary for these bonds to be strong enough to withstand the temperatures, air flow velocity, and physical disturbances encountered during flight. Thus, strong adhesive bonding compounds are used to bond the fan inlet shroud fairings to the struts.

At times it is necessary to remove the fan inlet shroud fairings from the struts of the ring strut ring. After the fan inlet shroud is bonded to the struts and prior to field deployment, testing is performed to ensure that any electronic components within the fan inlet shroud fairing are operating adequately. Unsatisfactory fan inlet shroud fairings must be removed and replaced with properly working fan inlet shroud fairings. Additionally, fan inlet shroud fairings may become inoperable following use in the field, such as after bird strike events. Inoperable fan inlet shroud fairings must also be removed and replaced. Removing the fan inlet shroud fairing from a ring strut ring can cause damage to the strut or other parts of the ring strut ring. If the strut or other parts of the ring strut ring are damaged, the damage must be repaired or the entire ring strut ring replaced. The ring strut ring is generally a more expensive component to repair or replace than the cumulative value of the fan inlet shroud fairings. Therefore, it is desirable to remove the fan inlet shroud fairing from a strut without causing damage to the ring strut ring.

### SUMMARY

An apparatus according to the present invention includes a carriage, a first tooth, a second tooth, a feed block for guiding the carriage and a drive element. The first tooth is shaped for breaking bonds and attached to a first side of the carriage. The second tooth is shaped for breaking bonds and attached to the first side of the carriage. The first tooth and the second tooth are spaced apart and generally parallel to each other. The drive element is connected to the feed block and the carriage and moves the carriage with the first tooth and the second tooth along a path away from the feed block so that the first tooth and the second tooth break bonds encountered along the path.

A component removal tool includes a guide assembly, a tooth assembly and a drive element. The guide assembly has a feed block, a leading edge support, a guide arm and a guide rail. The feed block guides the drive element. The guide arm extends from the feed block to the leading edge support. The guide rail extends from the feed block and is spaced from and generally parallel to the guide arm. The tooth assembly includes a carriage, a first tooth, and a second tooth. The first tooth and the second tooth are both attached to a first side of the carriage and spaced apart and parallel to each other. The carriage carries the first and second teeth. The drive element is connected to the feed block and the carriage and moves the tooth assembly from the feed block toward the leading edge support so that the first tooth and the second tooth break bonds between components positioned in between the carriage and the leading edge support.

A method for removing a bonded component from a structure includes positioning a tool having first and second teeth with respect to the component and the structure so that the first tooth is inserted between a first trailing edge of the component and a first trailing edge of the structure and the second tooth is inserted between a second trailing edge of the component and a second trailing edge of the structure. The method includes driving the first and second teeth from the first and second trailing edges of the structure towards a leading edge of the structure to break bonds between the component and the structure. The method further includes removing the component from the structure.

### BRIEF DESCRIPTION OF THE DRAWINGS

FIG. 1 is a partial view of a fan inlet case having a ring strut ring and fan inlet shroud fairings.

FIG. 2 is a cross section view of a bonded fan inlet shroud fairing and strut.

FIG. 3 is a perspective view of a component removal tool.

FIG. 4 is a flow diagram illustrating a method for removing a fan inlet shroud fairing from a strut.

FIG. 5 is a top view of a component removal tool, fan inlet shroud fairing and strut.

FIG. 6 is a top view of a component removal tool operating on a fan inlet shroud fairing.

### DETAILED DESCRIPTION

The present invention relates to a component removal tool and method. More particularly, the present invention relates to a tool and method capable of removing a fan inlet shroud fairing from a strut of a ring strut ring while eliminating or minimizing damage to the strut. The tool and method are described with reference to a fan inlet shroud fairing and a strut in gas turbine engines. However, similarly shaped components can also be separated according to the present invention.

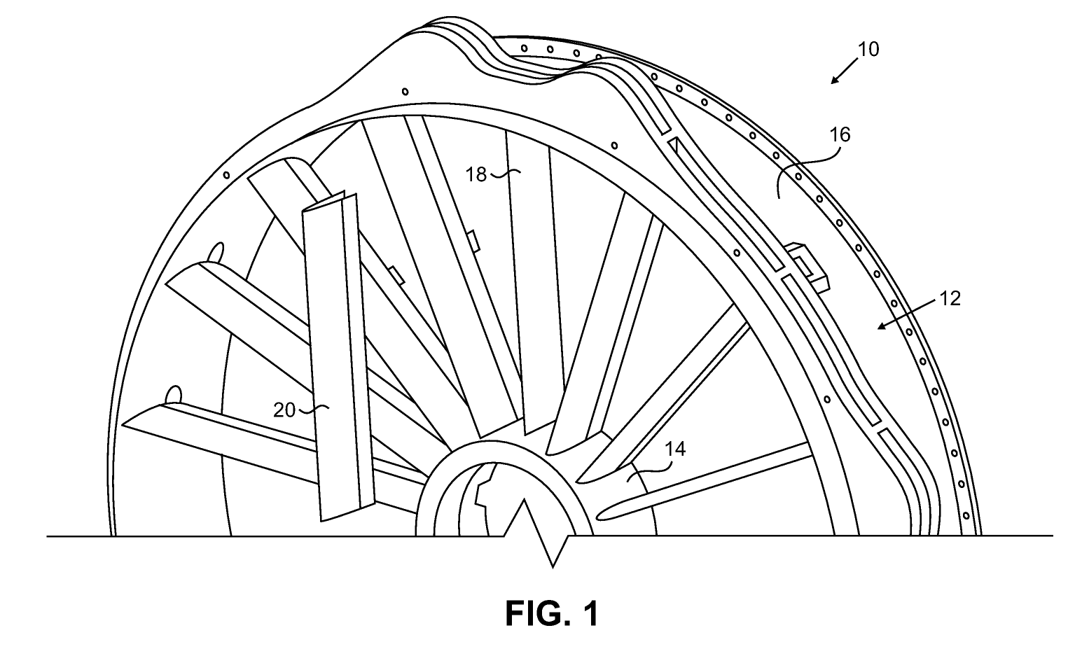

FIG. 1 illustrates part of a gas turbine fan inlet case 10 having a ring strut ring 12. Ring strut ring 12 includes inner ring 14, outer ring 16 and inner strut 18. Inner ring 14 and outer ring 16 are circular rings. Outer ring 16 is concentric with inner ring 14 and has a larger diameter than inner ring 14. Inner struts 18 extend between inner ring 14 and outer ring 16. For example, in one gas turbine fan inlet case 10, ring strut ring 12 contains seventeen inner struts 18. However, more or fewer inner struts 18 may be present within ring strut ring 12 depending on the diameters of inner ring 14 and outer ring 16 and the type of gas turbine engine. Each inner strut 18 is surrounded by one fan inlet shroud fairing 20. One such fan inlet shroud fairing 20 is shown cut away from inner strut 18 in FIG. 1. Fan inlet shroud fairing 20 is typically bonded to ring strut ring 12 at inner strut 18. Fan inlet shroud fairing 20 generally covers the entire radial length of inner strut 18. For example, in one gas turbine fan inlet case 10, fan inlet shroud fairing is about 43 centimeters (17 inches) in length.

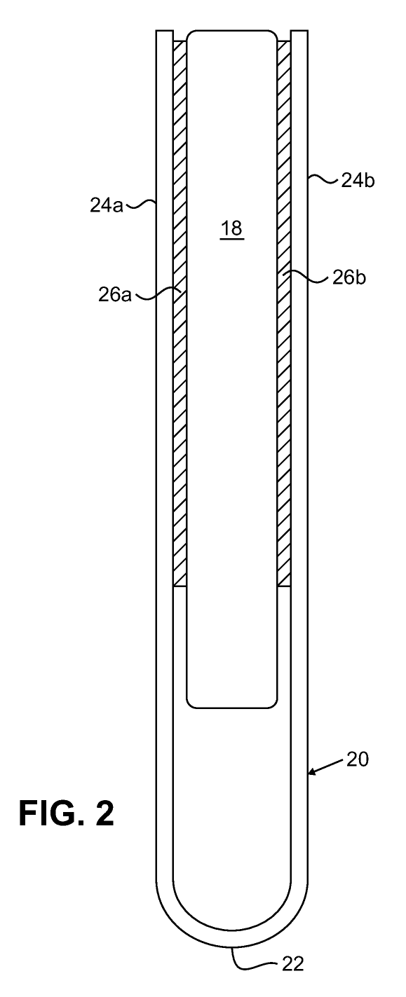

FIG. 2 illustrates a cross section view of fan inlet shroud fairing 20 bonded to inner strut 18. Fan inlet shroud fairing 20 includes leading edge 22 and two trailing edges 24a and 24b, forming a generally U-shaped component. Fan inlet shroud fairing 20 is positioned around inner strut 18. Fan inlet shroud fairing 20 and inner strut 18 are bonded together at two locations. First bond 26a is formed along one side of inner strut 18 and the interior side of fairing trailing edge 24a. Second bond 26b is formed along the other side of inner strut 18 and the interior side of fairing trailing edge 24b. First and second bonds 26a and 26b must be strong so that fan inlet shroud fairing 20 does not become dislodged from inner strut 18 during operation of the gas turbine engine. Silicone adhesives are frequently used to form first and second bonds 26a and 26b between fan inlet shroud fairing 20 and inner strut 18, but other bonding agents may also be used.

Fan inlet shroud fairing 20 often contains embedded electrical components such as sensors and heating elements for ice protection. When these electrical components fail or malfunction or fan inlet shroud fairing 20 becomes damaged, fan inlet shroud fairing 20 must be removed from inner strut 18 and replaced. Because first and second bonds 26a and 26b between fan inlet shroud fairing 20 and inner strut 18 are strong, the removal of fan inlet shroud fairing 20 can be difficult. Care must be taken so that ring strut ring 12 and inner strut 18 are not damaged. To prevent damage, unnecessary torque and bending loads must not be applied to ring strut ring 12 or inner strut 18. The method and component removal tool according to the present invention prevent unnecessary stress to inner strut 18 during fan inlet shroud fairing 20 removal.

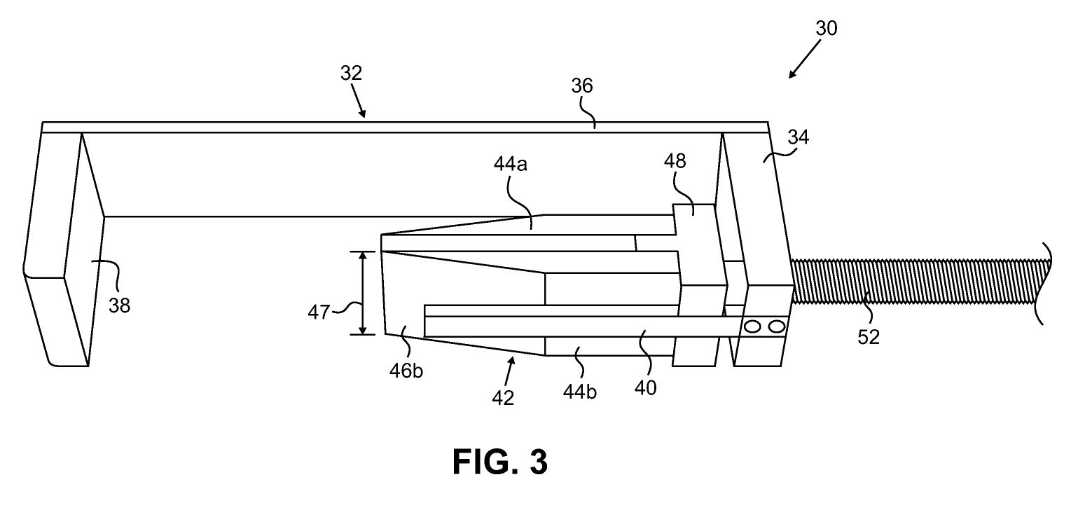

FIG. 3 illustrates one embodiment of component removal tool 30 suitable for removing fan inlet shroud fairing 20 from inner strut 18 of ring strut ring 12 without causing significant damage to inner strut 18 or ring strut ring 12. Component removal tool 30 includes guide assembly 32, tooth assembly 42 and drive element 52. Guide assembly 32 provides support for component removal tool 30 during use and guides tooth assembly 42. Tooth assembly 42 is configured to engage trailing edges 24a and 24b of fan inlet shroud fairing 20 to weaken and remove first and second bonds 26a and 26b between fan inlet shroud fairing 20 and inner strut 18 so that fan inlet shroud fairing 20 can be easily removed from ring strut ring 12. Drive element 52 is configured to drive tooth assembly 42 from trailing edges 24a and 24b of fan inlet shroud fairing 20 towards leading edge 22.

Guide assembly 32 of the component removal tool 30 illustrated in FIG. 3 includes feed block 34, guide arm 36, leading edge support 38, and guide rail 40. Feed block 34 serves as a backstop for tooth assembly 42, a support for guide arm 36 and guide rail 40, and a back plate and guide for drive element 52. Feed block 34 is located at a back end of guide assembly 32. Tooth assembly 42 is located in front of feed block 34. When tooth assembly 42 is located at its farthest position from leading edge support 38, a back surface of tooth assembly 42 is adjacent or proximal to a front surface of feed block 34. Feed block 34 prevents tooth assembly 42 from travelling farther backwards. One end of guide arm 36 and one end of guide rail 40 are attached to and extend from feed block 34. Guide arm 36 is attached to a first side of feed block 34 and extends forward from feed block 34. Guide rail 40 is attached to a second side of feed block 34 and also extends forward from feed block 34. Feed block 34 also serves as a back plate and guide for drive element 52. When drive element 52 pushes tooth assembly 42 forward, force is applied back to feed block 34. Feed block 34 aligns and guides drive element 52 to properly engage with tooth assembly 42. In one embodiment, feed block 34 is a metal, such as steel.

Guide arm 36 is connected to and extends forward from feed block 34. Guide arm 36 serves as a support for component removal tool 30 to allow it to engage fan inlet shroud fairing 20 without transferring significant force to the ring strut ring. When bonded component removal tool 30 is engaged with fan inlet shroud fairing 20, guide arm 36 is located on one side of fan inlet shroud fairing 20. In one embodiment, guide arm 36 is located in close proximity to the exterior side of fan inlet shroud fairing 20 so that it does not interfere with other fan inlet shroud fairings 20 in fan inlet case 10. At the same time, guide arm 35 is spaced from the exterior side of fan inlet shroud fairing 20 so that it does not provide mechanical interference with fan inlet shroud fairing 20 during removal. In one embodiment, guide arm 36 is a metal, such as stainless steel or aluminum. Guide arm 36 has a length sufficient to allow tooth assembly 42 to engage with trailing edges 24a and 24b of fan inlet shroud fairing 20 and allow leading edge support 38 to engage with leading edge 22 of fan inlet shroud fairing 20. In one embodiment, guide arm has a length of about 31.8 cm (12.5 inches).

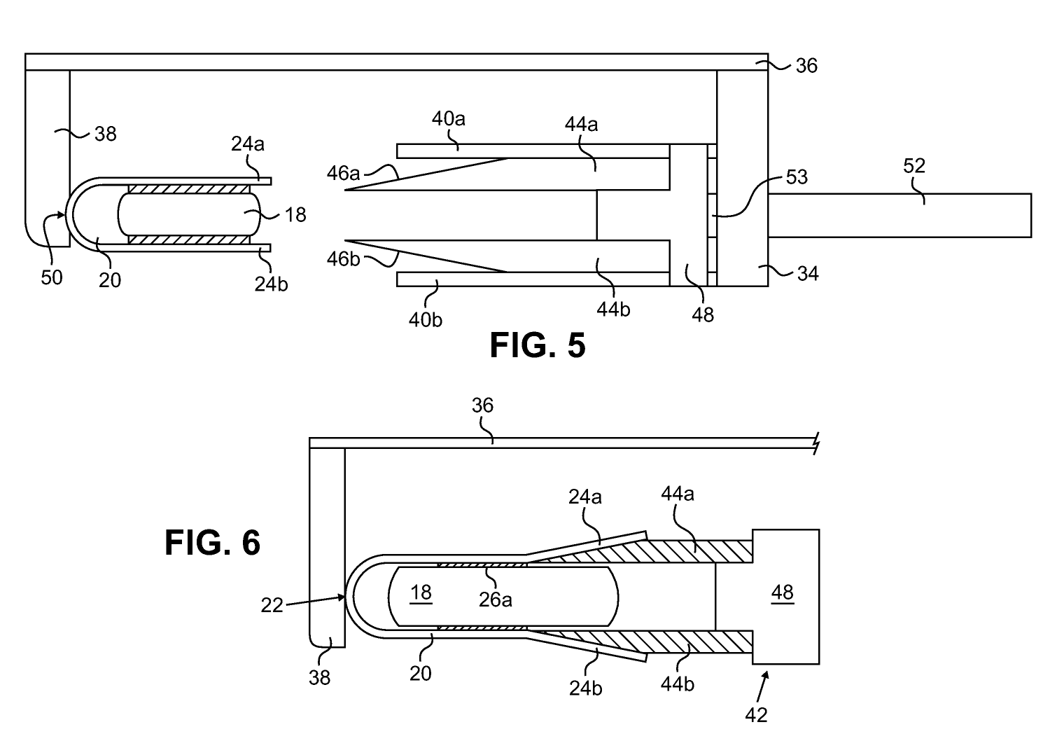

Leading edge support 38 is attached to a forward end of guide arm 36 and is generally perpendicular to guide arm 36. During component removal, leading edge support 38 abuts or engages with leading edge 22 of fan inlet shroud fairing 20. Leading edge support 38 serves as a guide when component removal tool 30 is positioned around fan inlet shroud fairing 20. Leading edge support 38 also prevents fan inlet shroud fairing 20 from moving forward during component removal, eliminating the transfer of force to the ring strut ring during removal. By holding fan inlet shroud fairing 20 in place, tooth assembly 42 is able to engage first and second bonds 26a and 26b between fan inlet shroud fairing 20 and inner strut 18. In one embodiment, leading edge support 38 contains groove 50 in which leading edge 22 of fan inlet shroud fairing 20 engages. Groove 50 serves to stabilize fan inlet shroud fairing 20 during component removal. FIG. 5 illustrates one embodiment where leading edge support 38 includes groove 50.

Guide rail 40 is connected to and extends forward from feed block 34. Guide rail 40 guides tooth assembly 42 and prevents tooth assembly 42 from leaving guide assembly 32 during component removal. Guide rail 40 is positioned to allow tooth assembly 42 to travel from feed block 34 towards leading edge support 38 and vice versa. Tooth assembly 42 slides between guide arm 36 and guide rail 40 as it travels. In one embodiment, component removal tool 30 includes one guide rail 40. As shown in FIG. 3, guide rail 40 is attached to the side of feed block 34 opposite guide arm 36. Guide rail 40 can also be to other sides of feed block 34 as long as it allows tooth assembly 42 to travel from feed block 34 towards leading edge support 38 and vice versa. In another embodiment, guide assembly contains two guide rails 40a and 40b. FIG. 5 illustrates one embodiment of component removal tool 30 with guide rails 40a and 40b.

Tooth assembly 42 of the component removal tool 30 illustrated in FIG. 3 includes first tooth 44a, second tooth 44b, and carriage 48. First and second teeth 44a and 44b are configured to remove first and second bonds 26a and 26b between fan inlet shroud fairing 20 and inner strut 18. First tooth 44a is configured to engage and remove first bond 26a. Second tooth 44b is configured to engage and remove second bond 26b. First tooth 44a is generally parallel to and spaced from second tooth 44b. In the embodiment shown in FIG. 3, a front portion of carriage 48 spaces first and second teeth 44a and 44b. First and second teeth 44a and 44b are spaced such that forward ends 46a and 46b of first and second teeth 44a and 44b are able to engage first and second bonds 26a and 26b, respectively between fan inlet shroud fairing 20 and inner strut 18 without damaging inner strut 18. Guide rail 40 combined with groove 50 aligns tooth assembly 42 with first and second bonds 26a and 26b.

To facilitate removal of first and second bonds 26a and 26b, forward ends 46 of first and second teeth 44a and 44b are generally tapered. First tooth 44a includes forward end 46a and second tooth 44b includes forward end 46b. First and second teeth 44a and 44b are shaped to provide a mechanical advantage during removal reducing the force required by drive element 52. In the embodiments shown in FIGS. 3, 5 and 6, first and second teeth 44a and 44b are wedges with tapered forward ends 46a and 46b. Both first tooth 44a and second tooth 44b have inner surfaces generally parallel to guide arm 36. Portions of the outer surfaces of first tooth 44a and second tooth 44b are inclined and taper towards forward ends 46a and 46b, respectively, of first and second teeth 44a and 44b to form wedges. Other tapered geometries for forward ends 46a and 46b can also be suitable for component removal tool 30. Tapered forward ends 46a and 46b of first and second teeth 44a and 44b allow teeth 44a and 44b to engage and remove first and second bonds 26a and 26b between fan inlet shroud fairing 20 and inner strut 18 while preventing damage to inner strut 18. The taper (angle) of forward ends 46a and 46b can be modified to reduce damage potential to inner strut 18 or reduce the number of bond breakage steps before fan inlet shroud fairing 20 can be removed from inner strut 18.

First and second teeth 44a and 44b are constructed so they cause no or minimal damage to inner strut 18 or ring strut ring 12 during operation but are strong enough to remove first and second bonds 26a and 26b between fan inlet shroud fairing 20 and inner strut 18. Materials used for first and second teeth 44a and 44b have sufficient mechanical strength so that teeth 44a and 44b do not break or bend significantly and retain their shape during operation of component removal tool 30 so that they can be reused for subsequent removal operations. At the same time, the tooth material hardness is sufficiently lower than the ring strut ring material hardness to reduce or prevent damage to inner strut 18 and ring strut ring 12. In one embodiment, first and second teeth 44a and 44b are constructed of polymeric materials, such as plastics. For example, first and second teeth 44a and 44b can be polyamides, such as nylon. Teeth 44a and 44b generally have a height 47 (forming a surface that interacts with bonds 26) between about 2.5 cm (1 inch) and about 38.1 cm (15 inches). Teeth height 47 can be modified to increase interactions with bonds 26a and 26b (increase height 47) or provide additional structural integrity to teeth 44a and 44b where bonds 26a and 26b are particularly strong (decrease height 47).

Carriage 48 is attached to first and second teeth 44a and 44b and configured to carry first and second teeth 44a and 44b during operation of component removal tool 30. Carriage 48 is positioned between first and second teeth 44a and 44b and feed block 34. First and second teeth 44a and 44b are connected to carriage 48 and extend forward from carriage 48. In conjunction with guide assembly 32, carriage 48 holds tooth assembly 42 within component removal tool 30. In one embodiment, carriage 48 includes a groove for receiving and engaging guide rail 40. The groove engages with guide rail 40 so that carriage 48 and, thereby, tooth assembly 42 is retained within guide assembly 32. The grooved engagement between carriage 48 and guide rail 40 permits movement of carriage 48 forwards and backwards from feed block 34 towards leading edge support 38 but limits other movement of carriage 48 and tooth assembly 42. FIG. 3 illustrates one embodiment where carriage 48 is grooved to engage guide rail 40. Carriage 48 also engages with a forward end of drive element 52. When drive element 52 is activated, carriage 48 is moved forwards or backwards along an axis between feed block 34 and leading edge support 38. Carriage 48 carries first and second teeth 44a and 44b as it moves. In one embodiment, carriage 48 is a metal, such as steel or aluminum.

Drive element 52 moves tooth assembly 42 within guide assembly 32 along a path between feed block 34 and leading edge support 38. Various types of drive elements 52 are suitable for use in component removal tool 30. Where teeth height 47 is large, multiple drive elements 52 can be used to accommodate the increased teeth height and ensure force is evenly applied along first and second bonds 26a and 26b by first and second teeth 44a and 44b. In the embodiment shown in FIG. 3, drive element 52 is a screw feed. Drive element 52 engages a rear end of carriage 48. Feed block 34 contains a threaded opening through which drive element 52 passes. Drive element 52 is also threaded. A rear end of drive element 52 is rotated to move tooth assembly 42. When drive element 52 is rotated in one direction, drive element 52 pushes tooth assembly 42 forward toward leading edge support 38 and away from feed block 34. When drive element 52 is rotated in the opposite direction, drive element 52 pulls tooth assembly 42 towards feed block 34 and away from leading edge support 38. In one embodiment, drive element 52 is a metal, such as steel. In one embodiment, the rear end of drive element 52 is configured to engage with a drive mechanism, such as a torque wrench, socket wrench, ratchet or pneumatic, hydraulic or electric motor, to aid in rotation of drive element 52.

In another embodiment of component removal tool 30, drive element 52 is controlled by a pressurized fluid. Tooth assembly 42 can be driven by pneumatic drive element 52. Pressurized air (or other suitable gases) is used to move tooth assembly 42 rather than a screw feed. Pneumatic drive element 52 is a pneumatic cylinder or actuator extending through a portion of feed block 34 so that a portion 53 of pneumatic drive element 52 is spaced between feed block 34 and carriage 48. Pneumatic drive element 52 is secured to feed block 34 so that a piston in pneumatic drive element 52 can move carriage 48 away from or towards feed block 34 using pressurized air. In another embodiment, tooth assembly 42 is driven by hydraulic drive element 52. A pressurized fluid, such as oil, is used to move tooth assembly 42. Drive element 52 is a hydraulic cylinder extending through a portion of feed block 34 spaced between feed block 34 and carriage 48. FIG. 3 illustrates component removal tool 30 where drive element 52 is controlled by a pressurized fluid. Drive element 52 can also move tooth assembly 42 using cams and levers, springs and other mechanisms.

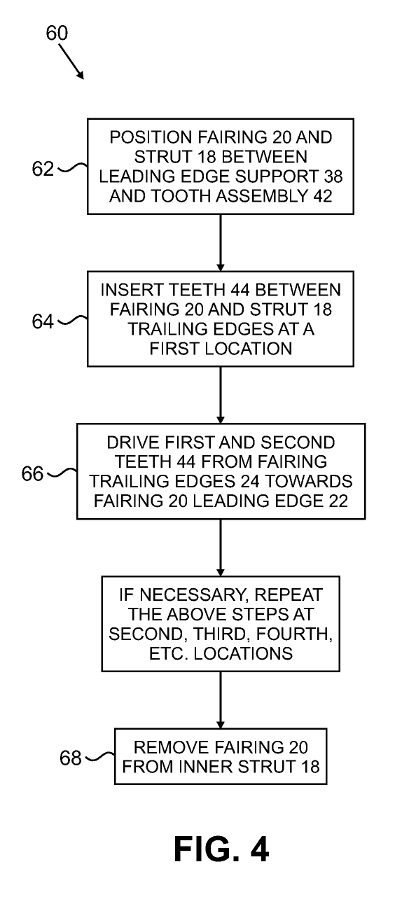

Component removal tool 30 illustrated in FIG. 3 and described above provides for a method for removing a bonded fan inlet shroud fairing from a strut. FIG. 4 is a flow diagram illustrating method 60. Method 60 includes positioning fan inlet shroud fairing 20 and inner strut 18 between leading edge support 38 and tooth assembly 42 (step 62). Tooth assembly is aligned and positioned so that first tooth 44a is inserted between fan inlet shroud fairing 20 trailing edge 24a and inner strut at a first radial location and second tooth 44b is inserted between fan inlet shroud fairing 20 trailing edge 24b and inner strut at the first radial location (step 64). Step 66 includes driving first and second teeth 44a and 44b from fan inlet shroud fairing 20 trailing edges 24a and 24b towards fan inlet shroud fairing 20 leading edge 22. If necessary, steps 62, 64, and 66 are repeated at second, third, and fourth radial locations or until fan inlet shroud fairing 20 can be removed from inner strut 18 (step 68) with no or minimal damage to inner strut 18.

In order to operate component removal tool 30 using method 60, ring strut ring 12 is removed from the gas turbine engine in which it is a component. Removal of ring strut ring 12 provides access to trailing edges 24 of fan inlet shroud fairing 20 and inner strut 18. During step 62, guide assembly 32 is positioned around fan inlet shroud fairing 20 and inner strut 18 so that leading edge 22 of fan inlet shroud fairing 20 is located near or engaged with (at groove 50) leading edge support 38. FIG. 5 illustrates fan inlet shroud fairing 20 leading edge 22 engaged with leading edge support 38 at groove 50. Tooth assembly 42 is generally aligned with trailing edges 24a and 24b of fan inlet shroud fairing 20 and inner strut 18.

In step 64, first and second teeth 44a and 44b are inserted between trailing edges 24a and 24b, respectively, of fan inlet shroud fairing 20 and inner strut 18. Drive element 52 is activated to move tooth assembly 42 forward towards trailing edges 24a and 24b of fan inlet shroud fairing 20. Once tooth assembly 42 is near trailing edges 24a and 24b, tooth assembly 42 is positioned and aligned so that first tooth 44a and second tooth 44b can engage respective first and second bonds 26a and 26b between fan inlet shroud fairing 20 and inner strut 18. The spacing of first and second teeth 44a and 44b on carriage 48 is adjusted to correspond with the width of inner strut 18, if necessary.

In step 66, tooth assembly 42 is driven forward, towards leading edge 22 of fan inlet shroud fairing 20, by drive element 52. As tooth assembly 42 moves forward first tooth 44a engages first bond 26a and second tooth 44b engages second bond 26b. Once engaged, teeth 44a and 44b break bonds 26a and 26b, respectively, between fan inlet shroud fairing 20 and inner strut 18. As tooth assembly 42 progresses towards leading edge 22, first and second teeth 44a and 44b break bonds 26a and 26b and push trailing edges 24a and 24b of fan inlet shroud fairing 20 outward and away from inner strut 18. FIG. 6 illustrates first and second teeth 44a and 44b pushing trailing edges 24a and 24b, respectively, of fan inlet shroud fairing 20 away from inner strut 18 as tooth assembly 42 moves towards leading edge 22.

Steps 62, 64 and 66 are initially performed at a first radial location along fan inlet shroud fairing 20. As described above, fan inlet shroud fairing 20 covers inner strut 18, which extends from inner ring 14 to outer ring 16 of ring strut ring 12. In some cases, inner strut 18 is so long and bonds 26a and 26b between fan inlet shroud fairing 20 and inner strut 18 are so strong that performing steps 62, 64 and 66 at one location on fan inlet shroud fairing 20 is insufficient to be able to completely break bonds 26a and 26b and remove fan inlet shroud fairing 20 from inner strut 18. In these cases, steps 62, 64 and 66 must be repeated at one or more additional locations along fan inlet shroud fairing 20 and inner strut 18. Depending on the dimensions of teeth 44a and 44b, the strength of bonds 26a and 26b and the length of fan inlet shroud fairing 20, steps 62, 64 and 66 may need to be performed at multiple radial locations before fan inlet shroud fairing 20 can be removed from inner strut 18. A desired number of iterations of steps 62, 64 and 66 can be established by modifying component removal tool 30. For example, increasing the taper (angle) of forward ends 46a and 46b of teeth 44a and 44b, respectively, or increasing the surface area of teeth 44a and 44b exposed to bonds 26a and 26b, respectively, (teeth height 47) can reduce the number of radial locations steps 62, 64 and 66 need to be performed. In an exemplary embodiment, steps 62, 64 and 66 would be performed four or fewer times in order to remove fan inlet shroud fairing 20 from inner strut 18.

In step 68, fan inlet shroud fairing 20 is removed from inner strut 18. Once bonds 26a and 26b between fan inlet shroud fairing 20 and inner strut 18 have been sufficiently broken, fan inlet shroud fairing 20 can be fully separated from inner strut 18. Once bonds 26a and 26b are broken, component removal tool 30 can be disengaged from fan inlet shroud fairing 20 and inner strut 18. Fan inlet shroud fairing 20 can separate from inner strut 18 during or after disengagement of component removal tool 30.

The component removal tool and method of the present invention provide for removal of components such as fan inlet shroud fairings bonded to structures such as struts in a ring strut ring. The tool and method allow for component removal while minimizing or eliminating damage to the structure.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. An apparatus comprising:
a carriage;
a first tooth shaped for breaking bonds and attached to a first side of the carriage;
a second tooth shaped for breaking bonds and attached to the first side of the carriage, wherein the first tooth and the second tooth are spaced apart and generally parallel to each other;
a feed block for guiding the carriage; and
a drive element connected to the feed block and the carriage for moving the carriage with the first tooth and the second tooth along a path away from the feed block so that the first tooth and the second tooth engage and break bonds encountered along the path.

2. The apparatus of claim 1, further comprising:
a leading edge support for positioning a component having bonds to be broken within the apparatus along the path; and
a guide arm extending from the feed block to the leading edge support.

3. The apparatus of claim 2, further comprising:
a guide rail spaced from and generally parallel to the guide arm and extending from the feed block for guiding the carriage along the path between the feed block and the leading edge support.

4. The apparatus of claim 1, wherein the first tooth and the second tooth are wedges having inclined outer surfaces.

5. The apparatus of claim 1, wherein the first tooth and the second tooth are polymeric materials.

6. The apparatus of claim 5, wherein the first tooth and the second tooth are polyamides.

7. The apparatus of claim 1, wherein the drive element is a screw feed.

8. The apparatus of claim 1, wherein the drive element moves the carriage using pressurized fluids.

9. The apparatus of claim 1, wherein the carriage comprises a groove such that the guide rail slides within the groove.

10. A component removal tool comprising:
a guide assembly comprising:
a feed block, wherein the feed block provides a first end of the guide assembly and guides a drive element;
a leading edge support, wherein the leading edge support provides a second end of the guide assembly opposite the first end;
a guide arm extending from the feed block to the leading edge support; and
a guide rail spaced from and generally parallel to the guide arm and extending from the feed block;
a tooth assembly slidable between the guide arm and the guide rail comprising:
a carriage;
a first tooth attached to a first side of the carriage;
a second tooth attached to the first side of the carriage, wherein the first tooth and the second tooth are spaced apart and parallel to each other, and wherein the carriage carries the first tooth and the second tooth; and
a drive element connected to the feed block and the carriage for moving the tooth assembly from the feed block toward the leading edge support so that the first tooth and the second tooth break bonds between components positioned in between the carriage and the leading edge support as the carriage moves from the feed block toward the leading edge support.

11. The component removal tool of claim 10, wherein the first tooth and the second tooth are wedges having inclined outer surfaces.

12. The component removal tool of claim 10, wherein the first tooth and the second tooth are polyamides.

13. The component removal tool of claim 10, wherein the drive element is a screw feed.

14. The component removal tool of claim 10, wherein the drive element moves the tooth assembly using pressurized fluids.

15. The component removal tool of claim 10, wherein the carriage comprises a groove such that the guide rail slides within the groove.

16. A method of removing a bonded component from a structure, the method comprising:
positioning a tool having first and second teeth with respect to the component and the structure so that the first tooth is inserted between a first trailing edge of the component and a first trailing edge of the structure and the second tooth is inserted between a second trailing edge of the component and a second trailing edge of the structure;
driving the first and second teeth from the first and second trailing edges of the structure towards a leading edge of the structure to break bonds between the component and the structure; and
removing the component from the structure.

17. The method of claim 16, wherein the first and second teeth are wedges having inclined outer surfaces.

18. The method of claim 16, wherein the component is a fairing and the structure is a strut.

19. The method of claim 16, wherein driving the first and second teeth towards a leading edge of the structure pushes the first and second trailing edges of the component away from the structure.

20. The method of claim 16, wherein driving the first and second teeth towards a leading edge of the structure is carried out using a drive element selected from the group consisting of a screw feed, a pneumatic cylinder and a hydraulic cylinder.
